(19) United States
(12) Patent Application Publication
(10) Pub. No.: US 2007/0079775 A1
(43) Pub. Date: Apr. 12, 2007

(54) Welding Forged Steel Single Piece Piston and Its Manufacturing Methods

(76) Inventors: Fenghua Lin, Binzhou City (CN); Xuejun Ma, Binzhou City (CN); Guohua Zhang, Binzhou City (CN); Hongmin Wang, Binzhou City (CN); Junkui Zhu, Binzhou City (CN); Lixia Wang, Binzhou City (CN); Zhanyu Gao, Binzhou City (CN); Shushan Zhang, Binzhou City (CN)

Correspondence Address: GLOBAL IP SERVICES, 2462 ROCK ST., APT. 6, MOUNTAIN VIEW, CA, 94043, US

(21) Appl. No.: 11/278,715

(22) Filed: Apr. 5, 2006

(30) Foreign Application Priority Data
Oct. 8, 2005 (CN) 200510044840.9

(51) Int. Cl. F02F 3/00

(52) U.S. Cl. 123/41.35; 123/193.6

(57) ABSTRACT

The present invention has provided a welding forged steel single piece piston and its manufacturing methods. A semi-finished head and a semi-finished skirt are forged respectively; the semi-finished head and semi-finished skirt are heat-treated respectively; rough machining is carried out respectively to the semi-finished head and the semi-finished skirt, and a face of weld between the two adjacent ring grooves is higher than the one under the combustion chamber; the head and the skirt are welded together through friction welding; an annular groove, a combustion chamber, a ring groove, a pinhole, an outer annulus and oil inlet/outlet holes are manufactured respectively; and the surface of the piston is phosphorized and graphitized. Compared with one-piece forged piston, it has better processing technology, because the head and skirt are forged respectively and then welded together. Over-all structural rigidity of the piston has been increased, and distortion of the ring groove in high temperature is slight because the cooling oil recess is sealed through welding. As the annular groove is located on the upper part of skirt, the weight of body of the piston is lowered and this kind of structure can accelerate engine oil returning on, decrease the clearance between the piston and the cylinder and reduce the engine oil consumption.

### CROSS REFERENCE TO RELATED APPLICATION

This application claims the priority benefits of a Chinese patent application No. 200510044840.9 filed on Oct. 8, 2005.

### FIELD OF THE INVENTION

This invention has provided a kind of engine piston, especially a forged steel piston, and its manufacturing methods.

### BACKGROUND OF THE INVENTION

At present, engines used in trucks, engineering machinery, rail vehicles and ships are developed into that of high efficiency and heavy load with increased strength and strict discharge requirement. Aluminum pistons, although have the merit of light weight, are unable to meet high power, high strength and low discharge requirements of engines. Therefore, a type of hinged pendulum piston has been created, i.e. head and skirt of the piston, connected with piston pin are manufactured respectively. The head is usually made of cast iron or forged steel while the skirt is made of aluminum. As the head and skirt are manufactured respectively, it increases the processing cost, meanwhile, it is hard to form sealed cooling oil recess, which leads to poor cooling effect. Because of longer piston pin used for connection, the weight has been more or less increased. A kind of manufacturing method of single piece piston has been published by China patent application numbered CN1610601A. One-piece forging has been adopted in this method for semi-finished piston. Through a ring cap, the inner cooling oil recess, together with the ring chamber groove on the head, forms a sealed oil chamber. The manufacturing process of semi-finished piston and sealed oil chamber is complicated, and the structural strength is quite low.

### SUMMARY OF THE INVENTION

This invention aims to provide a welding forged steel single piece piston and its manufacturing methods to simplify the manufacturing process of semi-finished piston and improve its over-all structural strength.

The welding forged steel single piece piston has a forged head and a forged skirt, which are fixed together as a body of the piston by welding. There is a cooling oil recess in the piston between the ring groove and the combustion chamber. The cooling oil recess is connected with a inner chamber of the piston through oil inlet/outlet holes. An annular groove is located on the upper part of the skirt which is under the ring groove. The annular groove is connected with the inner chamber of the piston in the direction of major axis.

The above-mentioned manufacturing methods include:
a) a semi-finished head and a semi-finished skirt are forged respectively;
b) the semi-finished head and semi-finished skirt are heat-treated respectively;
c) rough machining is carried out respectively to the semi-finished head and the semi-finished skirt in order to produce a inner chamber, inner cooling oil recess and face of friction welding. Meanwhile the face of weld between the two adjacent ring grooves is higher than the one under the combustion chamber;
d) the semi-finished head and semi-finished skirt are welded through friction welding;
e) an annular groove (7), combustion chamber (2), ring groove (9), pinhole (5), outer annulus and oil inlet/outlet hole (8) are manufactured respectively;
f) the surface of the piston is phosphorized and graphitized.

Compared with one-piece forged piston, the welding forged steel single piece piston manufactured by the above-mentioned structure and methods have better processing technology, because the head and skirt are forged respectively and then welded together. The forging of the semi-finished piston and the forming process of the sealed cooing oil recess have been simplified, and the residual stress of the semi-finished piston is weak. The over-all structural rigidity of the piston has been increased, and the distortion of the ring groove in high temperature is slight, because the cooling oil recess is sealed through welding. As the annular groove is located on the upper part of the skirt and connected with the inner chamber of the piston in the direction of major axis, the weight of the body of the piston has been lowered, this kind of structure also accelerate engine oil returning on. Meanwhile, it improves the flexibility of skirt, which decreases the clearance between the piston to the cylinder and reduces engine oil consumption. It can take place of the aluminum piston and hinged pendulum piston with light weight and higher strength to meet the requirements of heavy load engines.

### BRIEF DESCRIPTION OF THE DRAWINGS

FIG. 1 is a Front view of the cross section of the welding forged steel single piece piston.

FIG. 2 is a Left side view of the cross section of the welding forged steel single piece piston.

FIG. 3 is a perspective view of the welding forged steel single piece piston.

FIG. 4 is a Front view of the cross section of semi-finished head after rough machining.

FIG. 5 is a Front view of the cross section of semi-finished skirt after rough machining.

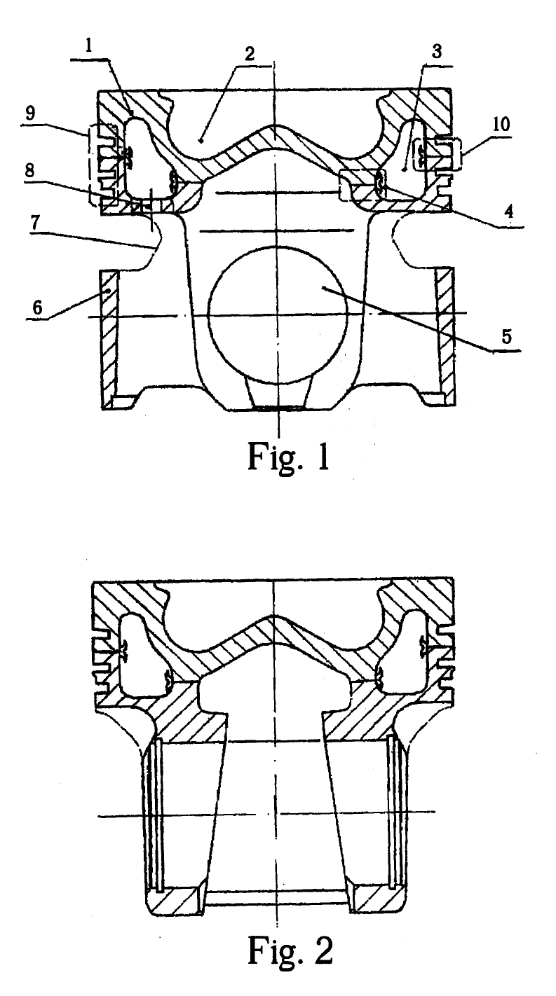

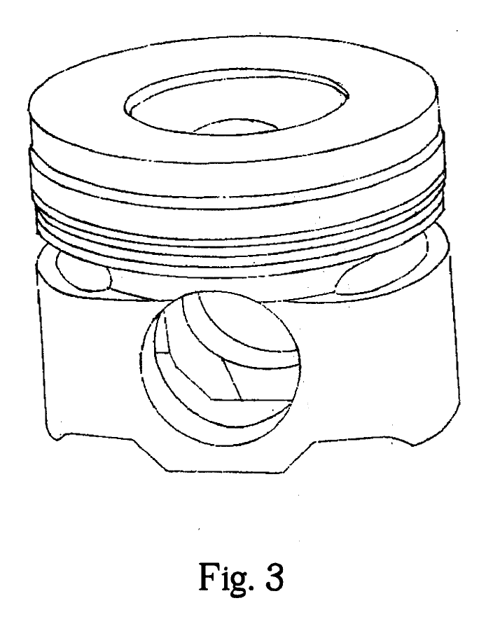

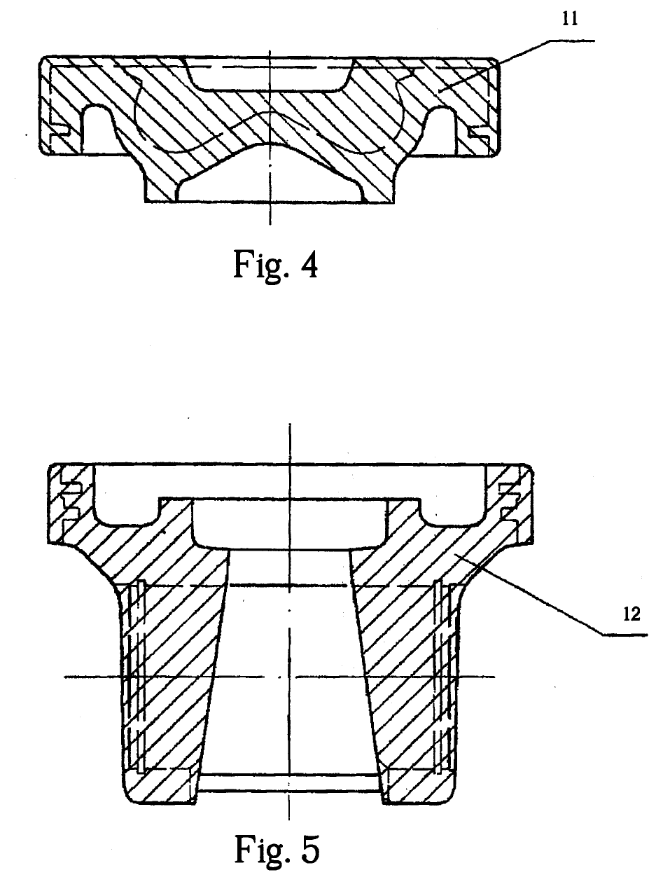

Numbers in the figures: 1—head, 2—combustion chamber, 3—cooling oil recess, 4—face of weld, 5—pinhole, 6—skirt, 7—annular groove, 8—oil inlet/outlet hole, 9—ring groove, 10—face of weld, 11—semi-finished head, 12—semi-finished skirt.

### DETAIL DESCRIPTION OF THE INVENTION

Structures and manufacturing methods are described in detail with attached drawings as follows.

Although the following detailed description contains many specifics for the purposed of illustration, any one of ordinary skill in the art will appreciate that many variations and alterations to the following details are within the scope of the invention. Accordingly, the following preferred embodiment of the invention is set forth without any loss of generality to, and without imposing limitations upon, the claimed invention.

As illustrated in the figures, a welding forged steel single piece piston has a forged head (1) and a forged skirt (6), which are welded and fixed as a body of the piston. There is a cooling oil recess (3) on the piston between the ring groove (9) and the combustion chamber (2). The cooling oil recess is connected with the inner chamber of the piston through oil inlet/outlet holes (8). An annular groove (7) is located on the upper part of the skirt which is under the ring groove. It is connected with the inner chamber of the piston in the direction of major axis.

The above-mentioned head (1) and skirt (6) are welded through the face of weld (4) under the combustion chamber and the face of weld (10) between the two adjacent ring grooves. The face of weld between the two adjacent ring grooves is higher than the one under the combustion chamber. Thus, the face of weld between the two adjacent ring grooves is located between the first ring groove and the second ring groove. The body of the piston at this place is quite thick compared with other parts of the piston; therefore, it is easy for friction welding.

There is a groove on the lower part of semi-finished head used to form the upper part of cooling oil recess, and there is a groove on the upper part of semi-finished skirt used to form the lower part of cooling oil recess. The semi-finished head and skirt shall be welded together to form the integrated cooling oil recess, which is connected with inner chamber of the piston through two or three oil inlet/outlet holes. When the piston is working in the engine, engine oil will flow in through one oil inlet/outlet hole, and vibrate in the cooling oil recess. Then it will flow out through another oil inlet/outlet hole taking away the heat in the body of the piston and the heat especially around the combustion chamber to lower the working temperature of the piston and to ensure the operational reliability of the piston and the piston ring.

The annular groove located on the upper part of skirt is connected with the inner chamber of the piston in the direction of major axis. Therefore, this kind of structure lowers the weight of the piston body, accelerates engine oil in the area near the annular groove returning on and improves the flexibility of skirt, which decreases the clearance between the piston and the cylinder and reduces the engine oil consumption.

If it is necessary to keep away from the oil nozzle installed on the body of the engine, a breach can be designed on the lower part of the piston to prevent it from interfering with the nozzle when moving to the bottom dead point.

Semi-finished head and skirt are made of forgeable quenched and tempered steel or non quenched and tempered steel. When taking heat treatment to semi-finished head and skirt respectively.

Norm for quenched and tempered steel are: heating for 1-2 hours under 800-850° C., then oil-cooled, and tempering temperature shall be 600° C. ±10° C., heating for 1.5-2.5 hours.

Norm for non quenched and tempered steel, air-cooled to room temperature, and make sure that the temperature shall be reduced from 1100° C. (after being forged) to 500° C. within 3-4 minutes.

What is claimed is:

1. A welding forged steel single piece piston comprising a forged head; a forged skirt welded and fixed with said forged head as a body of said piston; a cooling oil recess located in the piston between a ring groove and a combustion chamber, said cooling oil recess is connected with the inner chamber of said piston through oil inlet/outlet holes; an annular groove located on the upper part of said skirt and under the ring groove, said annular groove is connected with the inner chamber of said piston in the direction of major axis.

2. The welding forged steel single piece piston of claim 1, wherein said head and said skirt are welded together.

3. The welding forged steel single piece piston of claim 2, wherein the face of weld between the two adjacent ring grooves is higher than the face of weld under the combustion chamber, the two said faces are welded together.

4. Method for manufacturing of forged steel single piece piston comprises:
a) forge a semi-finished head and a semi-finished skirt respectively;
b) heat-treat the semi-finished head and the semi-finished skirt respectively;
c) rough machining the semi-finished head and the semi-finished skirt respectively in order to produce an inner chamber, an inner cooling oil recess and faces of friction welding, Meanwhile, the face of weld between two adjacent ring grooves is higher than the face of weld under a combustion chamber;
d) weld the semi-finished head and the semi-finished skirt together through friction welding;
e) manufacture an annular groove, a combustion chamber, a ring groove, a pinhole, an outer annulus and oil inlet/outlet holes respectively;
f) phosphoric and graphitiz the surface of said piston.

5. The method of claim 4, wherein the process of said heat treatment for the piston made of quenched and tempered steel are: heating for 1-2 hours under 800-850° C., then oil-cooled, then tempering under temperature 600° C.±10° C. for 1.5-2.5 hours.

6. The method of claim 4, wherein the process of said heat treatment for the piston made of non quenched and tempered steel are: air-cooled to room temperature, and make sure that the temperature shall be reduced from 1100° C. (after being forged) to 500° C. within 3-4 minutes.
